(19) United States
(12) Patent Application Publication
(10) Pub. No.: US 2026/0225614 A1
(43) Pub. Date: Aug. 6, 2026

(54) SYSTEMS AND METHODS FOR TRAINING A DATA-DRIVEN PLANNER USING RULES-BASED OPTIMIZATION PLANNER PARAMETERS

(71) Applicant: Toyota Jidosha Kabushiki Kaisha, Toyota-shi (JP)

(72) Inventors: Peyman Yadmellat, Palo Alto, CA (US); Ana Sofia Rufino Ferreira, Palo Alto, CA (US)

(73) Assignee: Toyota Jidosha Kabushiki Kaisha, Toyota-shi (JP)

(21) Appl. No.: 19/042,620

(22) Filed: Jan. 31, 2025

(51) Int. Cl. B60W 60/00

(52) U.S. Cl. CPC B60W 60/0013

(57) ABSTRACT

In one embodiment, an autonomous vehicle includes one or more processors and a non-transitory computer-readable medium storing instructions that, when executed by the one or more processors, cause the one or more processors to receive a driving preference, receive local scene data, input the local scene data into a data-driven planner and an iterative trajectory optimization planner, generate, using the data-driven planner, a DDP output includes a DDP trajectory based at least in part on the local scene data and the driving preference, input the DDP output into the iterative trajectory optimization planner, where the DDP output is used as a cost of a plurality of costs of a cost function that is minimized by the iterative trajectory optimization planner, and generate, using the iterative trajectory optimization planner, an output trajectory.

### BACKGROUND

In an autonomous vehicle software stack, the planning module (i.e., “the planner”) is responsible for determining what an autonomous vehicle should do according to the current situation. One type of a planner is a rules-based planning module that selects a trajectory by minimizing a cost function that takes into account a plurality of costs, such as keeping within a lane boundary, speed limit, comfort (i.e., jerk control), obstacle avoidance, and others. As this type of planner is rules-based, it may cause the autonomous vehicle to maneuver in a manner that is not expected by a passenger, particularly when encountering complex scenarios. In some cases, the rules-based optimization planner may select a trajectory that feels unnatural, such as taking too wide of a turn when turning right or left at an intersection.

Recently, machine learning (ML) planners have been developed. ML planners include a trained model that is trained by real-time human driving and/or simulated driving. ML planners may provide a more human-like driving experience, such as human-like lateral positioning with a lane, human-like turns and others. However, although ML planners can successfully navigate typical situations, ML planners may have difficulty in very rare scenarios. Additionally, ML planners may more frequently break rules of the road and behave in an unexpected manner. Further, the ML planner may produce trajectories that are commensurate with one driving style (e.g., aggressive) that are not commensurate with another driving style (e.g., passive), which may lead to passenger discomfort, unease, and/or frustration.

Accordingly, alternative autonomous vehicle planning modules and methods for training ML planners may be desired.

### BRIEF SUMMARY

In one embodiment, an autonomous vehicle includes one or more processors and a non-transitory computer-readable medium storing instructions that, when executed by the one or more processors, cause the one or more processors to receive a driving preference, receive local scene data, input the local scene data into a data-driven planner and an iterative trajectory optimization planner, generate, using the data-driven planner, a DDP output includes a DDP trajectory based at least in part on the local scene data and the driving preference, input the DDP output into the iterative trajectory optimization planner, where the DDP output is used as a cost of a plurality of costs of a cost function that is minimized by the iterative trajectory optimization planner, and generate, using the iterative trajectory optimization planner, an output trajectory.

In another embodiment, a method of training an autonomous vehicle includes receiving a plurality of sets of parameters of an iterative trajectory optimization planner, where each set of parameters of the plurality of sets of parameters corresponds with an individual driving preference indicative of a driving preference, receiving a plurality of sets of vehicle data of one or more vehicles operating using the iterative trajectory optimization planner, where each set of vehicle data of the plurality of sets of vehicle data corresponds with an individual set of parameters of the plurality of sets of parameters, and training, using the plurality of sets of parameters and the plurality of sets of vehicle data, a data-driven planner such that the data-driven planner outputs a DDP trajectory in accordance with a selected driving preference.

In another embodiment, a computing apparatus includes one or more processors and a non-transitory memory component storing instructions that, when executed by the one or more processors, configure the computing apparatus to receive a plurality of sets of parameters of an iterative trajectory optimization planner, where each set of parameters of the plurality of sets of parameters corresponds with an individual driving preference, receive a plurality of sets of vehicle data of one or more vehicles operating using the iterative trajectory optimization planner, where each set of vehicle data of the plurality of sets of vehicle data corresponds with an individual set of parameters of the plurality of sets of parameters, and train, using the plurality of sets of parameters and the plurality of sets of vehicle data, a data-driven planner such that the data-driven planner outputs a DDP trajectory in accordance with a selected driving preference.

### BRIEF DESCRIPTION OF THE SEVERAL VIEWS OF THE DRAWINGS

FIG. 1 illustrates an example hybrid planner for an autonomous vehicle according to one or more embodiments described and illustrated herein.

FIG. 2 illustrates an example hybrid planner for an autonomous vehicle according to one or more embodiments described and illustrated herein.

FIG. 3 illustrates an example iterative trajectory optimization planner of a hybrid planner for an autonomous vehicle according to one or more embodiments described and illustrated herein.

FIG. 4 illustrates an example data flow of a hybrid planner for an autonomous vehicle according to one or more embodiments described and illustrated herein.

FIG. 5 illustrates an example workflow for training a data-driven planner according to one or more embodiments described and illustrated herein.

FIG. 6 illustrates example training data according to one or more embodiments described and illustrated herein.

FIG. 7 illustrates example clusters of vehicle data according to one or more embodiments described and illustrated herein.

FIG. 8 illustrates an example autonomous vehicle according to one or more embodiments described and illustrated herein.

FIG. 9 illustrates example components of an autonomous vehicle according to one or more embodiments described and illustrated herein.

FIG. 10 illustrates an example computing device for training a data-driven planner according to one or more embodiments described and illustrated herein.

FIG. 11 illustrates an example method for training a data-driven planner according to one or more embodiments described and illustrated herein.

### DETAILED DESCRIPTION

Embodiments of the present disclosure are directed to autonomous vehicles having a software stack that includes a hybrid planning module (i.e., a hybrid planner) that combines attributes of both a machine learning (ML) planning module and a rules-based planning module. A ML planning module, referred to herein as a data-driven planner (DDP), utilizes a trained model to receive sensor and map data and produce a DDP trajectory. This DDP trajectory is then provided as an input to the rules-based planning module, referred to herein as an iterative trajectory optimization (ITO) planner, as a cost that is included among a plurality of other costs associated with a loss function. The iterative trajectory optimization planner, using the DDP trajectory, produces an output trajectory that is then converted into control signals that are used to autonomously control the autonomous vehicle.

The combination of both planner types takes advantage of the benefits of both a ML planner and rules-based optimization planner while minimizing the effect of their deficiencies. Inclusion of the DDP trajectory as a cost in the iterative trajectory optimization planner provides for a more human-like and natural trajectory executed by the autonomous vehicle that is appreciated by the passenger(s). The ML planner is leveraged to handle more complex scenarios, whereas the rules-based optimization planner is leveraged to handle rare events for which the ML planner has not been trained. Additionally, use of the iterative trajectory optimization planner ensures that the rules of the road are followed and that obstacles are avoided.

Embodiments of the present disclosure are also directed to systems and methods for training a data-driven planner to produce DDP trajectories according to different driving preferences. More specifically, parameters of the iterative trajectory optimization planner may be established so that the output trajectory is in accordance with a particular driving preference or style. For example, a first set of parameters may establish a “sport” driving preference, while a second set of parameters may establish a “comfort” driving preference. As another example, parameters such as variable speeds or follow distance preferences are set by the driver or user. In embodiments, these parameters of the iterative trajectory optimization planner are used as labels for training data to train the data-driven planner to produce trajectories according to different driving preferences (e.g., a sport preference and a comfort preference, among others).

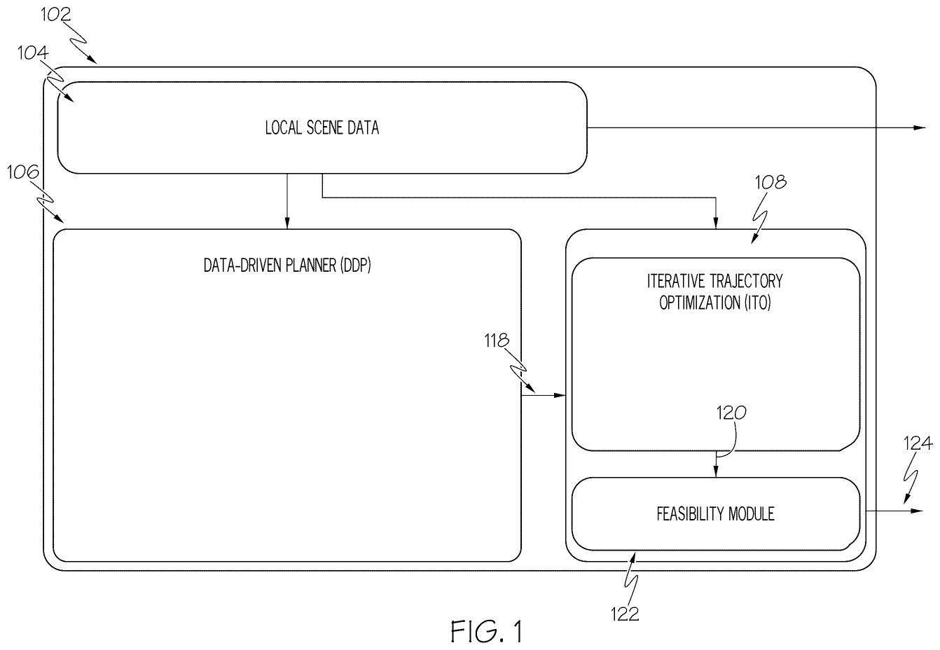

Referring now to FIG. 1, an example hybrid planner 102 of an autonomous software stack of an autonomous vehicle is schematically illustrated. It should be understood that other layers of the autonomous software stack are not shown for ease of illustration and brevity. The hybrid planner 102 generally includes a data-driven planner 106 that is machine-learning based and an iterative trajectory optimization planner 108 that is rules-based. The two planners are serially coupled such that the output of the data-driven planner 106 is provided as an input to the iterative trajectory optimization planner 108. Both the data-driven planner 106 and the iterative trajectory optimization planner 108 receive local scene data 104 that includes any type of data relating to the vehicle and the environment in which the autonomous vehicle is navigating. For example, the local scene data 104 may include vehicle sensor data, map data and external infrastructure data.

As described in more detail below, the data-driven planner 106 receives the local scene data 104 an produces one or more DDP outputs 118, where each output includes a plurality of DDP trajectories, a DDP path, and/or lead vehicle selections, using a machine-learning, data-driven approach. The DDP trajectory represents a set of spatial position, speeds and/or accelerations/decelerations of the vehicle along a time horizon that is human-like and thus typical of how a human driver would drive the autonomous vehicle. The DDP path represents a set of spatial positions of the vehicle up to a certain distance that a typical human driver would take to drive the autonomous vehicle. The lead vehicle selection represents a set of tags assigned to other road users, determining a lead object that a typical human driver would follow and keep distance with longitudinally. Each DDP output represents a different possible driving choice, where the iterative trajectory optimization planner can leverage to produce an iterative trajectory optimization output trajectory. In some embodiments, each DDP output 118 represents a different driving style and preference.

The iterative trajectory optimization planner 108 receives the local scene data 104 and the DDP output 118 as inputs. As described in more detail below, the iterative trajectory optimization planner 108 includes a loss function that is minimized to generate an ITO trajectory 120. The loss function accounts for a plurality of costs, one or more of which are based on the DDP output 118. Thus, the iterative trajectory optimization planner 108 produces an ITO trajectory 120 that attempts to closely follow the DDP trajectory of the DDP output 118, while also taking into consideration all of the other costs of the iterative trajectory optimization planner 108.

In some embodiments, the ITO trajectory 120 outputted by the iterative trajectory optimization planner 108 is provided to a feasibility module 122, which, as described in more detail below, checks the feasibility of the ITO trajectory 120 with respect to several requirements. When the feasibility of the ITO trajectory 120 is established the feasibility module 122 outputs an output trajectory 124 that is then provided to one or more additional layers of the autonomous vehicle software stack. Ultimately, the output trajectory 124 is converted into one or more control signals that control one or more actuators of the autonomous vehicle to autonomously control the autonomous vehicle within the environment.

It is noted that FIG. 1 illustrates that the local scene data 104 may also be provided to other components of the autonomous vehicle, such as other layers of the autonomous vehicle software stack or other vehicular systems, such as an advanced driver assist system, as a non-limiting example.

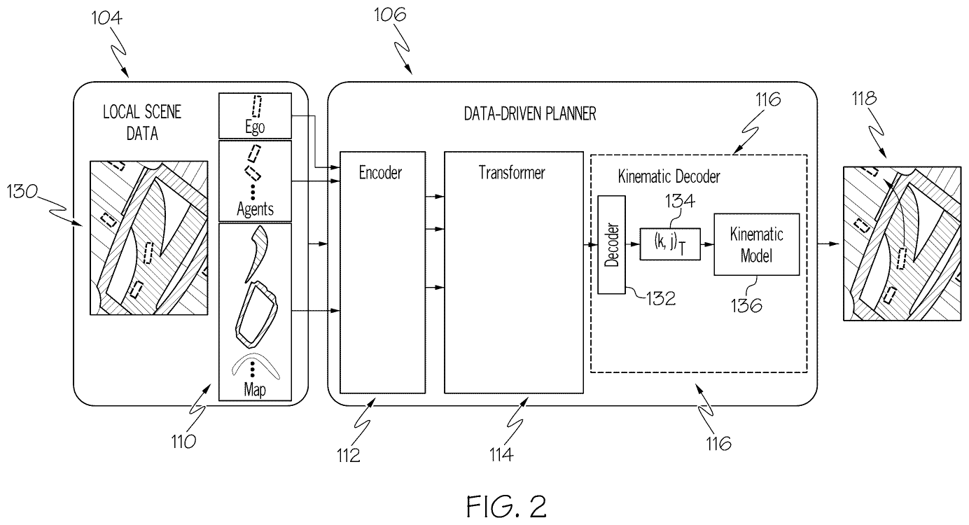

FIG. 2 illustrates the data-driven planner 106 in greater detail. It is noted that embodiments are not limited to the data-driven planner 106 of FIGS. 1 and 2, and that any machine-learning motion planner that produces a predicted trajectory may be utilized.

The local scene data 104, which may include vehicle sensor data, map data 130 (e.g., standard definition map data, enhanced standard definition map data, and/or high-definition map data), and infrastructure data (i.e., data obtained from sensors or other components external to the autonomous vehicle), is provided to the data-driven planner 106. In the example of FIG. 2, the local scene data 104 is processed into object representations 110, such as map representations, agent (e.g., other vehicles) representations, and ego (i.e., the autonomous vehicle) representations. More specifically, the object representations are vectorized polygon representations of the map data, agents and the autonomous vehicle. The vectorized object representations are referred to herein as “vectorized local scene data.” The local scene data that is converted into object representations by a vectorizer module. Each local scene object corresponds to one frame or timestep. As an example, the local scene data for consecutive frames is aggregated for consecutive frames and then passed to the vectorizer module, which converts the local scene representations to tensor/vectorized representations used an input to the data-driven planner 106.

The vectorized local scene data 104 is provided to the data-driven planner 106 as an input to a hierarchical graph network. The first level of the hierarchical graph network is an encoder that receives the vectorized local scene data and encodes it with local information. The object representations of the vectorized local scene data may include pose information, object type, time of observation, and other information. Thus, the encoder 112 learns encoding for the scene elements provided by the local scene data 104.

For example, the encoder 112 may include two separate sub-components that generate two local subgraphs: one for encoding agents/ego, and one for encoding map elements of the local scene data. The ego/agents local subgraph captures temporal information for each agent over multiple frame (i.e., it is a temporal encoding network). The local map subgraph operates over all map elements in the current frame and is not capturing temporal information. As a non-limiting example, the encoder 112 may be a PointNet-based local subgraph. It should be understood that other encoder architectures may be used to generate an embedding vector for each agent, each map element, and the ego vehicle 138.

The second level of the hierarchical graph network is a transformer 114 that generates global embeddings by combining the local information of the encoder 112. The global embeddings of the transformer 114 are used for reasoning about interactions over agents and map features, and for translation into actions by way of a kinematic decoder 116. The transformer may include a transformer encoder architecture which uses multi-head self-attention plus feed-forward network blocks.

The global embeddings for each agent, each map element and the ego vehicle 138 may be provided to a kinematic decoder 116 that produces a DDP output 118 that includes a predicted trajectory. The kinematic decoder 116 may be used to ensure physical feasibility of the trajectory of the DDP output 118. More specifically, the kinematic decoder 116 includes a decoder 132 and a kinematic model 136. The kinematic decoder 116 receives the global embeddings from the transformer 114 and models the kinematics of the autonomous vehicle using a unicycle model. The kinematic decoder 116 may be a multilayer perceptron that predicts longitudinal jerk and curvature for each time step within a prediction horizon. The decoder 132 may be a neural network learnable module. The kinematic model 136, which may be a non-learnable model, receives these predictions as well as the current state of the autonomous vehicle to roll out the next state of the autonomous vehicle. The kinematic model 136 includes parameters for vehicle kinematic constraints, such as maximum allowed jerk, acceleration, curvature, and steering angle, which are used to clip controls to ensure physical feasibility. The result is the DDP output 118, which includes a DDP trajectory that is then provided to the iterative trajectory optimization planner 108 to be used as one or more costs.

In some embodiments, the kinematic decoder 116 is replaced by a learnable neural network decoder that is trained based on vehicle parameters and constraints. The neural network decoder may also be trained or fine-tuned using vehicle parameters to output physically feasible trajectories without the need for the kinematic decoder described above.

The data-driven planner 106 may be trained using imitation learning to train a driving policy that mimics expert driving behavior by minimizing the L1 loss between the poses generated by the model and ground truth poses. Perturbations to extend the distribution of states seen during training may be included and thus reduce the impact of the covariate shift. Large values of jerk and curvature may be penalized to reduce jerk and improve driving comfort. As a non-limiting example, the final loss is:

$$L = {\sum }_{t = 1}^{T} ‖ {p}_{t} - {\hat{p}}_{t} ‖ 1 + α ‖ {k}_{t} ‖ 2 + β ‖ {j}_{t} ‖ 2 , \qquad Eq . ( 1 )$$

Where pₜ is the predicted pose (xₜ, yₜ, θₜ) at time t, \hat{p}ₜ is the target pose, and α and β are hyperparameters.

It should be understood that embodiments of the present disclosure are not limited to training by imitation learning, and that other training methods may be utilized, such as reinforcement learning.

Additional information regarding the data-driven planner 106 is found at Vitelli et al., “SafetyNet: Safe planning for real-world self-driving vehicles using machine-learned policies.” As stated above, other machine-learning, data-based planner architectures may be used to produce a DDP output 118 that is used as a cost in a rules-based optimization planner, such as the iterative trajectory optimization planner 108.

In some embodiments, the data-driven planner 106 produces a plurality of DDP outputs 118 according to different parameters or preferences. For example, the data-driven planner 106 may produce different DDP output 118 according to various comfort levels, wherein one DDP output 118 may correspond with a DDP trajectory that corresponds to an aggressive, sport mode, and another DDP output 118 corresponds with a comfort preference. As described in more detail below, the iterative trajectory optimization planner 108 may choose which DDP output 118 to select when generating an output trajectory.

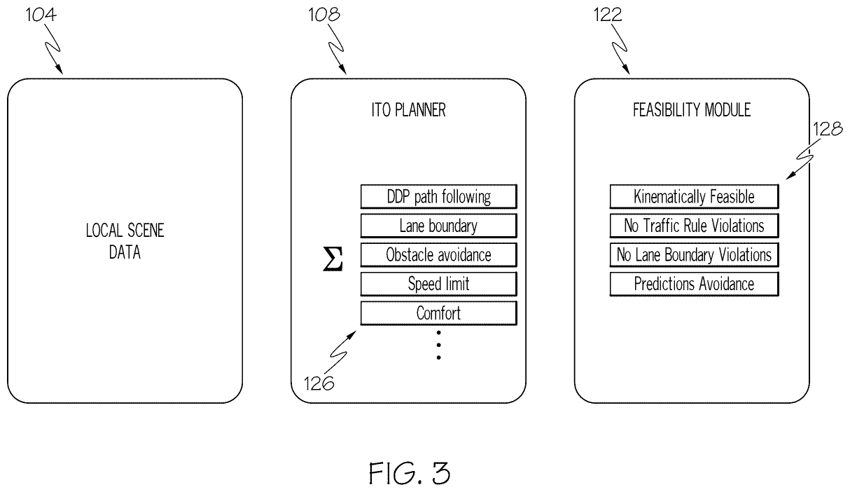

FIG. 3 illustrates the iterative trajectory optimization planner 108 and the feasibility module 122 in greater detail. The local scene data 104, which may include vehicle sensor data, map data (e.g., standard definition map data, enhanced standard definition map data, and/or high-definition map data), and infrastructure data (i.e., data obtained from sensors or other components external to the autonomous vehicle), is provided to the iterative trajectory optimization planner 108. The local scene data 104 may or not be processed in a manner that it suitable for it to be received by the iterative trajectory optimization planner 108.

The iterative trajectory optimization planner 108 solves a trajectory optimization problem in the form of a cost function. Any known or yet-to-be-developed trajectory optimization problem algorithm may be utilized. As a non-limiting example, iterative linear quadratic regulation (iLQR) may be used to solve a trajectory optimization problem that optimizes for a plurality of costs 126, one of which being the DDP output 118, and a plurality of hard and/or soft constraints (e.g., constraints on the optimization variables or any combinations of those variables). The plurality of costs 126 may include costs that are included in traditional rules-based optimization planners, such as, without limitation, lane boundary keeping, obstacle avoidance, speed limit, and comfort (i.e., jerk). The hard constraints may be, without limitation, obeying vehicle dynamics, maximum steering rate, and maximum jerk input. The soft constrains may be, without limitation, obstacle avoidance and lane boundary avoidance. The iterative trajectory optimization planner 108 outputs an ITO trajectory 120 having minimized costs associated with the cost function.

Embodiments are not limited by any particular cost function. The cost function may be engineered to have any type and number of costs. In embodiments of the present disclosure, the data-driven planner 106 provides the DDP output 118 to the iterative trajectory optimization planner 108. The DDP output 118 may provide any number of costs to the iterative trajectory optimization planner 108. For example, the DDP output may provide a DDP path cost (i.e., the path the autonomous vehicle travels), a DDP speed cost (i.e., the speed the vehicle travels), and/or DDP heading cost (i.e., the heading of the autonomous vehicle).

More specifically, a trajectory includes a sequence of future states to be visited by the vehicle, and may be parameterized by factors such as time, travelled distance and other parameters. Accordingly, a trajectory may be a sequence of waypoints {wᵢ}=0, . . . , N, each associated with a time instance, tᵢ. Time instance, tᵢ, may range in some examples from some initial time to a planning horizon look-ahead time t_{N}. The waypoints may be vectors typically consisting of vehicle Cartesian coordinates, heading angle (orientation), velocity and acceleration. If the waypoint time evolution is governed by some dynamics equations, the waypoints may be referred to as state vectors or states.

A non-limiting optimized-based motion plan of the iterative trajectory optimization planner 108 may be formulated in its generic discrete-time form as:

$${min}_{{u}_{0} , {u}_{N - 1}} J ( w , u ) = {ℓ}_{N} ( {w}_{N} ( {t}_{N} ) ) + {\sum }_{i = 0}^{N - 1} {ℓ}_{i} ( {w}_{i} , {u}_{i} ) , \qquad Eq . ( 2 a )$$

$$subject to : {w}_{i + 1} = f ( {w}_{i} , {u}_{i} ) , \qquad Eq . ( 2 b )$$

$$( {w}_{i} , {u}_{i} ) ∈ {C}_{i} , i = 0 … , N - 1 , \qquad Eq . ( 2 c )$$

$${w}_{N} ∈ {C}_{N} , . \qquad Eq . ( 2 d )$$

Where Eq. (2a) represents the cost function that is being optimized (in this case—minimized) by a selection of control inputs {uᵢ}. Equation (2b) represents dynamics equations derived from the vehicle dynamics model, that define how the control inputs affect the evolution of waypoints (states) and Eq. (2c)-(2d) define constraints on waypoints (states) and on control variables. Components [symbol] ᵢ promote or regulate behaviors such as, for example, lane following, maintaining a distance from obstacles, motion progress along the lane, and comfort metrics.

The ITO trajectory 120 produced by the iterative trajectory optimization planner 108 is then provided to the feasibility module 122, which checks the feasibility according to several characteristics 128, such as kinematic feasibility, legality (i.e., no traffic rule violations), no lane boundary violations, and collision likelihood. For kinematic feasibility, the feasibility module 122 evaluates whether the ITO trajectory 120 remains within a feasible envelope characterized by the dynamics limits of the autonomous vehicle. More particularly, the feasibility module 122 evaluates each trajectory state of the ITO trajectory 120 and determines whether parameters such as longitudinal jerk, longitudinal acceleration, curvature, curvature rate, lateral acceleration, and steering jerk (curvature rate×velocity) are within acceptable bounds. Lane boundary feasibility checks to determine that each stage of the ITO trajectory 120 remains within the lane boundaries of the road. The legality feasibility checks each stage of the ITO trajectory 120 to make sure no traffic rules are violated, such as running a stop sign, violation of the right of way, running a red traffic light, and leaving a drivable surface, as non-limiting examples. The collision likelihood feasibility checks each stage of the ITO trajectory 120 for the likelihood of a collision with any other road agents using a prediction model that predicts poses of the other road agents. Generally collision detection may be performed by rasterizing future agent predictions and checking for overlaps with planned poses of the autonomous vehicle over the ITO trajectory.

When the feasibility module 122 indicates an ITO trajectory 120 is feasible, it is output as an output trajectory 124 that is ultimately used to control the autonomous vehicle. If the ITO trajectory 120 is infeasible, a fallback trajectory may be utilized, such as another candidate ITO trajectory 120.

In embodiments where the 108 receives multiple DDP outputs 118 from the data-driven planner 106, the iterative trajectory optimization planner 108 may select a single DDP output 118 as one or more costs to optimize. For example, the data-driven planner 106 may output a confidence score for each DDP output 118 and the iterative trajectory optimization planner 108 may select an individual DDP output 118 based on the confidence scores (e.g., select the DDP output 118 having the highest confidence score). As another example, the iterative trajectory optimization planner 108 may produce multiple ITO trajectories 120 using each DDP output 118 as one or more costs in individual optimizations. The feasibility module 122 may evaluate each of the ITO trajectories 120 and select the ITO trajectory 120 that is most feasible to be used as the output trajectory 124, for example.

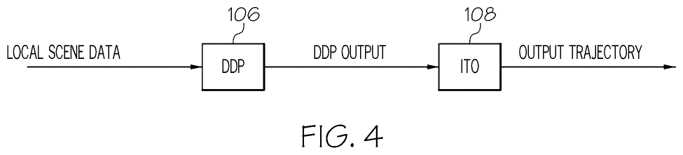

FIG. 4 is a simplified diagram of FIG. 1. As shown in FIG. 4, local scene data is provided as input to a data-driven planner 106, which produces a DDP output 118 that includes a predicted trajectory. The predicted trajectory of the data-driven planner 106 is provided as an input to an iterative trajectory optimization planner 108. The iterative trajectory optimization planner 108 uses the DDP output 118 as one or more costs to be minimized in a rules-based optimization planner. The one or more costs associated with the DDP output 118 included with a plurality of other costs that are to be minimized by the iterative trajectory optimization planner 108, such as lane keeping, speed limit and others. The iterative trajectory optimization planner 108 produces an output trajectory that is then used to control the autonomous vehicle within an environment without human intervention.

Some embodiments are directed to systems and methods for training the data-driven planner 106 to produce DDP trajectories that are tailored to a particular driving preference. Different drivers have different driving preferences. Whereas one drive may drive aggressively by quickly accelerating, taking turns quickly, and braking hard, another driver may drive more passively by slowly accelerating, taking turns slowing, and braking with plenty of braking distance. There are other driving preferences or styles, such as an eco-preference where the trajectories are optimized to minimize fuel or battery charge.

Therefore, it is desirable for the data-driven planner 106 to be trained to produce trajectories according to a selected driving preference. However, it is difficult to train the data-driven planner 106 for different driving preferences because training data in the form of real-world driving according to the different driving preferences is not readily available. In embodiments of the present disclosure, the parameters (i.e., weights, constants and constraints) of the iterative trajectory optimization planner 108 are leveraged as training data 144 to train the data-driven planner 106 to produce DDP trajectories (i.e., the DDP output 118) according to different driving preferences.

The cost function of the iterative trajectory optimization planner 108 is modified to change the output trajectory 124 according to a driving preference. Thus, a plurality of cost functions correspond to a plurality of driving preferences. For example, the parameters of a first cost function may correspond to a sport preference (i.e., an aggressive driving style) that allows for closer following of a lead vehicle, faster acceleration, looser lane keeping constraints, and other driving characteristics. The parameters of a second cost function may correspond to a comfort preference (i.e., a passive driving style) that provides a large gap between the ego vehicle and a lead vehicle, slower acceleration, tighter lane keeping constraints, and other driving characteristics. Thus, Eqs. (2a)-(2d) may be specifically tailored to a particular driving preference.

When the cost functions for the different driving preferences are developed and known, they can be used as training data to train the data-driven planner 106. Thus, the parameters may be used as training labels to label training data in a supervised learning process. In some embodiments, the training labels can be used to cluster data into different driving styles.

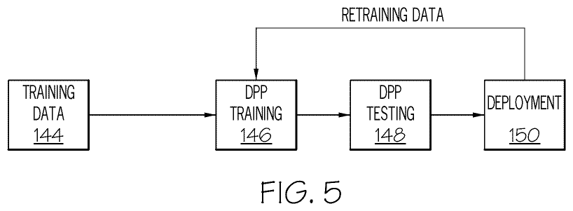

FIG. 5 illustrates an example data-driven planner training process. Training data 144 is provided to the DDP training block 146 to train the data-driven planner. Any known or yet-to-be-developed training method may be utilized. As a non-limiting example, the imitation learning method described above may be utilized. After training, the trained data-driven planner is tested at the DDP testing block 148. The DDP testing block 148 may be implemented by simulated driving in a simulated environment, and/or physical testing on a closed course or otherwise controlled physical environment. The testing process may be used to find error, issues or bugs that lead to undesirable outcomes. Once the trained data-driven planner 106 passes the DDP testing block 148, the trained data-driven planner 106 is then deployed to one or more autonomous vehicles for operation. The trained data-driven planner 106 may be deployed to the one or autonomous vehicles by a software update (e.g., over-the-air software update or a wired software update) or by other means. Retraining data in the form of local scene data 104 and trajectory information is provided back to the DDP training block 146 to be used as training data in a subsequent training process.

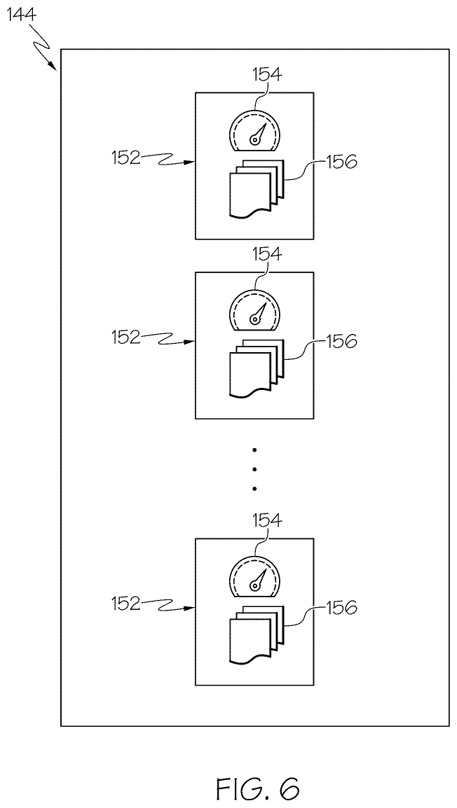

As noted above, the parameters from individual cost functions tailored to individual driving preferences are used as labels in the training data 144 to train the data-driven planner 106. Referring to FIG. 6, the training data 144 used to train the data-driven planner 106 is schematically illustrated. The training data 144 includes session data 152 over many autonomous driving sessions where autonomous vehicles were operated using an iterative trajectory optimization planner 108. Thus, each instance of the session data 152 includes the parameters 156 of the cost function of the iterative trajectory optimization planner 108, which may be tailored toward a particular driving preference. For example, one driving session driven by autonomous vehicle may have been controlled using a cost function that is associated with a sport preference, while another driving session driven by another autonomous vehicle may have been controlled using a cost function that is associated with a comfort preference. Because the preferences are known before training, the parameters 156 associated with the vehicle data 154 for the particular driving session of the session data 152 may be used as training labels. Thus, all of the vehicle data 154 (which includes the local scene data 104 and any other relevant data from the driving session) corresponding with parameters associated with an individual driving preference can be used as training data to train the data-driven planner 106 to produce DDP trajectories commensurate with the individual driving preference, such as an aggressive trajectory for a sport preference or a passive trajectory for a comfort preference.

The vehicle data 154 includes trajectories that were produced by the iterative trajectory optimization planner 108 and that the autonomous vehicles maneuvered during the driving sessions. Thus, the trajectories of the vehicle data 154 may be used as ground truth trajectories for a particular driving preference during the training process. In this manner, the data-driven planner 106 may be trained to produce trajectories in accordance with many different driving preferences.

A passenger in the autonomous vehicle may select a driving preference among a plurality of driving preferences, such as by using an electronic display, another input device, and/or by verbally speaking the driving preference. Once selected, the data-driven planner 106 will produce a DDP output 118 in accordance with the selected driving preference.

It is noted that in some embodiments, the autonomous vehicle does not include the iterative trajectory optimization planner 108. In such embodiments, the DDP output 118 includes a trajectory that is directly used by a motion planner of the autonomous vehicle. Thus, the autonomous vehicle is controlled solely by a machine-learning planner in the form of the data-driven planner 106.

In other embodiments, both the data-driven planner 106 and the iterative trajectory optimization planner 108 are utilized by the autonomous vehicle as illustrated by FIG. 1. When the user selects a selected driving preference, the parameters 156 of the cost function of the iterative trajectory optimization planner 108 are modified to produce output trajectories 124 according to the selected driving preference, and the data-driven planner 106 also produces a DDP output 118 according to the selected driving preference as well. In this manner, the DDP output 118 from the data-driven planner 106 will be closer to those iteratively produced by the iterative trajectory optimization planner 108, and therefore the autonomous vehicle will navigate the environment according to the driving preference.

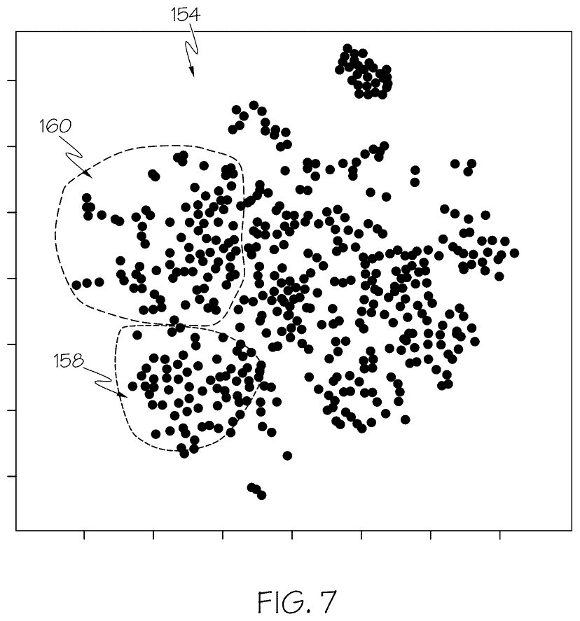

In some cases, the driving preferences associated the vehicle data 154 produced by the autonomous vehicles are unknown. For example, the cost functions of the iterative trajectory optimization planner 108 may not be associated with any particular driving preference. In such cases, the session data 152, which includes the vehicle data 154 and the parameters 156, may be clustered together based on similarity. As a non-limiting example, an encoder may be utilized to create embeddings of the session data 152. Then, a distance-based clustering algorithm may be used to form clusters of similar session data 152. FIG. 7 provides an illustrative example of vectorized vehicle data 154 embeddings that are clustered according to a clustering algorithm, such as a co-sign similarity algorithm. It should be understood that any type of clustering algorithm may be utilized.

FIG. 7 illustrates several clusters, such as a first cluster 158, which may include driving data indicative of a sport preference, and a second cluster 160, which may include driving data indicative of a comfort preference, for example. The parameters used by the iterative trajectory optimization planner 108 may be identified and then used to create a set a parameters associated with individual clusters and, therefore, individual driving preferences. As a non-limiting example parameters within an individual cluster may be averaged to create a set of parameters for that individual cluster. Autonomous vehicles operating with the set of parameters for certain driving preferences may then produce vehicle data 154 that can be used to train the data-driven planner 106 as described above. Further, the parameters of the different clusters may be used by the iterative trajectory optimization planner 108 to control the autonomous vehicle according to the selected driving style.

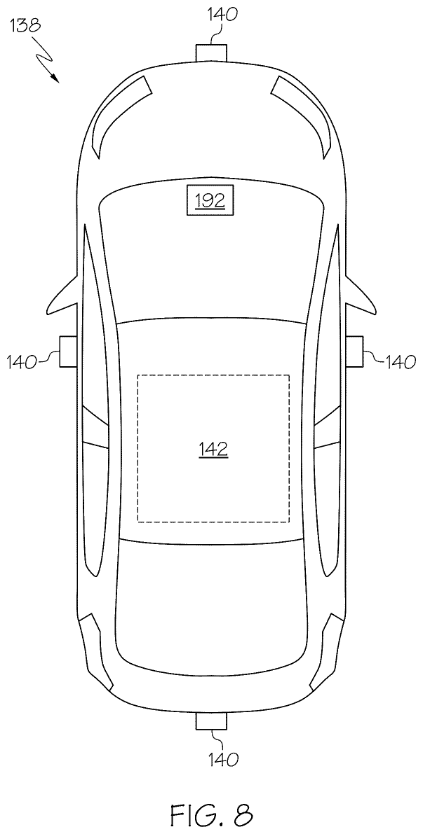

Referring now to FIG. 8, an example autonomous vehicle 138 is schematically illustrated. The vehicle 138 may be any type of autonomous vehicle. For example, the autonomous vehicle 138 may be a Level 4 or a Level 5 autonomous vehicle capable of driving without human intervention. The illustrated autonomous vehicle 138 has any number of sensors 140 that produce sensor data representing the local scene, such as cameras, lidar sensors, radar sensors, proximity sensors, speedometers, inertial measurement units (IMU), steering angle sensors, braking sensors, occupancy sensors, and any other sensor capable of detecting an attribute of the autonomous vehicle 138 and the environment in which the autonomous vehicle 138 is navigating. The sensors of the autonomous vehicle 138 also includes a global positioning system (GPS) device configured to receive locational data from one or more satellites orbiting the Earth. The autonomous vehicle 138 has an autonomous driving autonomous driving system 142 including a software stack capable of receiving sensor data from the plurality of sensors 140 and any other data source, and generating a trajectory that is used by the autonomous vehicle 138 to drive within the environment, including the hybrid planner 102 described herein.

The autonomous vehicle 138 also includes a plurality of actuator 192 operable to receive control signals from the autonomous driving system 142 and produce motion to move the autonomous vehicle within the environment. The actuator 192 may be, without limitation, an electric motor, an engine, a steering system, a brake, an accelerator, and any other component that produces physical movement of the autonomous vehicle 138. The hybrid planner 102 produces an output trajectory 124 that is converted into control signals by the autonomous driving system 142, which are then provided to the plurality of actuators that moves the vehicle such that it completes the output trajectory 124.

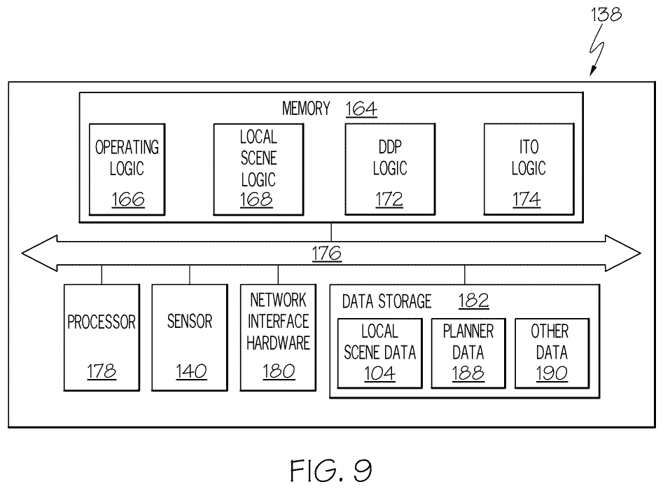

Referring now to FIG. 9, components of an example autonomous vehicle 138 is illustrated. The example autonomous vehicle 138 provides a system for producing an output trajectory and controlling an autonomous vehicle, and/or a non-transitory computer usable medium having computer readable program code for producing a trajectory and autonomously controlling the vehicle embodied as hardware, software, and/or firmware, according to embodiments shown and described herein. It should be understood that the software, hardware, and/or firmware components depicted in FIG. 9 may also be provided in multiple computing apparatuses or devices external to autonomous vehicle 138 depicted in FIG. 9 (e.g., data storage devices, remote server computing devices, and the like).

As also illustrated in FIG. 9, the autonomous vehicle 138 (or other computing apparatus) may include a one or more processors 178, one or more sensors 140, network interface hardware 180, and a data storage component 182 (which may store local scene data 104, planner data 188, and any other data 190 for performing the functionalities described herein), and a non-transitory memory component 164. The non-transitory memory component 148 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. In other embodiments, the memory component 148 may be defined by transitory memory and/or signals.

Additionally, the non-transitory memory component 164 may be configured to store operating logic 166 that provides a local operating system for the autonomous vehicle 138, local scene logic 168 for receiving and processing local scene data 104, DDP logic 172 for producing a DDP output that includes a predicted trajectory, and ITO logic 174 for receiving the DDP output and generating a rules-based output trajectory for controlling the autonomous vehicle 138 (each of which may be embodied as computer readable program code, firmware, or hardware, as an example). It should be understood that the data storage component 182 may reside local to and/or remote from the autonomous vehicle 138, and may be configured to store one or more pieces of data for access by the autonomous vehicle 138 and/or other components.

A local interface 176 is also included in FIG. 9 and may be implemented as a bus or other interface to facilitate communication among the components of the autonomous vehicle 138.

The one or more processors 178 may include any processing component configured to receive and execute computer readable code instructions (such as from the data storage component 182 and/or non-transitory memory component 164). The network interface hardware 180 may include any wired or wireless networking hardware, such as a modem, LAN port, wireless fidelity (Wi-Fi) card, WiMax card, mobile communications hardware, and/or other hardware for communicating with other networks and/or devices.

Included in the non-transitory memory component 164 may be the operating logic 166, local scene logic 168, DDP logic 172, and ITO logic 174. The operating logic 166 may include an operating system and/or other software for managing components of the autonomous vehicle 138 or computing apparatus. The local scene logic 168 may reside in the non-transitory memory component 164 and may be configured to receive local scene data 104 (e.g., sensor data and map data) and render or otherwise process the local scene data 104 for use by the DDP logic 172 and the ITO logic 174 (e.g., vectorize the local scene data into a plurality of object representations 110). The DDP logic 172 also may reside in the non-transitory memory component 164 and may be configured to produce a DDP output that includes a predicted trajectory based on the local scene data 104. The ITO logic 174 also may reside in the non-transitory memory component 164 and may be configured to receive the DDP output and generate a rules-based output trajectory using the DDP output as one or more costs that are minimized using a cost function. The output trajectory is used by the autonomous vehicle 138 for autonomous navigation.

It should be understood that the components illustrated in FIG. 9 are merely exemplary and are not intended to limit the scope of this disclosure. More specifically, while the components in FIG. 9 are illustrated as residing within the autonomous vehicle 138, this is a non-limiting example. In some embodiments, one or more of the components may reside external to the autonomous vehicle 138.

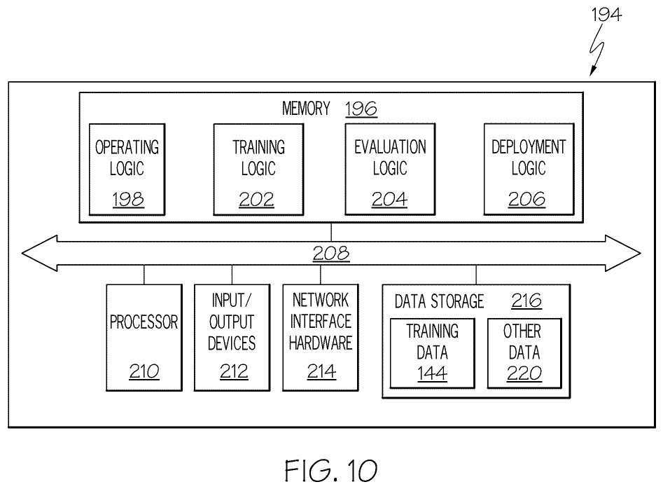

Referring now to FIG. 10, components of an example computing apparatus 194 is illustrated. The example computing apparatus 194 provides a system for training a data-driven planner to produce trajectories according to driving preferences, and/or a non-transitory computer usable medium having computer readable program code for training a data-driven planner to produce trajectories according to driving preferences embodied as hardware, software, and/or firmware, according to embodiments shown and described herein. It should be understood that the software, hardware, and/or firmware components depicted in FIG. 10 may also be provided in multiple computing apparatuses or devices external to computing apparatus 194 depicted in FIG. 10 (e.g., data storage devices, remote server computing devices, and the like).

As also illustrated in FIG. 10, the computing apparatus 194 may include a one or more processors 210, input/output devices 212, network interface hardware 214, and a data storage component 216 (which may store training data 144 and any other data 220 for performing the functionalities described herein), and a non-transitory memory component 196. The non-transitory memory component 196 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. In other embodiments, the non-transitory memory component 196 may be defined by transitory memory and/or signals.

Additionally, the computing apparatus 194 may be configured to store operating logic 198 that provides a local operating system for the computing apparatus 194, training logic 202 for training the data-driven planner, evaluation logic 204 for evaluating and testing the trained data-driven planner, and deployment logic 206 for deploying the trained data-driven planner to vehicles in the fleet (each of which may be embodied as computer readable program code, firmware, or hardware, as an example). It should be understood that the data storage component 216 may reside local to and/or remote from the computing apparatus 194, and may be configured to store one or more pieces of data for access by the computing apparatus 194 and/or other components.

A local interface 208 is also included in FIG. 10 and may be implemented as a bus or other interface to facilitate communication among the components of the computing apparatus 194.

The one or more processor 210 may include any processing component configured to receive and execute computer readable code instructions (such as from the data storage component 216 and/or non-transitory memory component 196). The input/output devices 212 include any device capable of providing input into the computing apparatus 194 (e.g., keyboards, touch screens, mouse devices, trackpads, microphones) and receiving output from the computing apparatus 194 (e.g., electronic displays, speakers, haptic devices) The network interface hardware 214 may include any wired or wireless networking hardware, such as a modem, LAN port, wireless fidelity (Wi-Fi) card, WiMax card, mobile communications hardware, and/or other hardware for communicating with other networks and/or devices.

Included in the non-transitory memory component 196 may be the operating logic 198, training logic 202, evaluation logic 204 and deployment logic 206. The operating logic 198 may include an operating system and/or other software for managing components of the computing apparatus 194. The training logic 202 may reside in the non-transitory memory component 196 and may be configured to receive training data 144 (e.g., local scene data an parameters) and train the data-driven planner to produce DDP trajectories in accordance with one or more driving preferences. The evaluation logic 204 also may reside in the non-transitory memory component 196 and may be configured to evaluate and test the trained data-driven planner to determine if the performance meets metrics and if there are any bugs or other issues. In some embodiments, the evaluation logic 204 includes operation of a simulated autonomous vehicle in a simulated embodiment. The deployment logic 206 also may reside in the non-transitory memory component 196 and may be configured to provide the trained data-driven planer and any other associated software code to vehicles of a fleet of vehicles, such as by an over-the-air update as a non-limiting example.

It should be understood that the components illustrated in FIG. 10 are merely exemplary and are not intended to limit the scope of this disclosure. More specifically, while the components in FIG. 10 are illustrated as residing within a single computing apparatus 194, this is a non-limiting example. In some embodiments, one or more of the components may reside external to the computing apparatus 194.

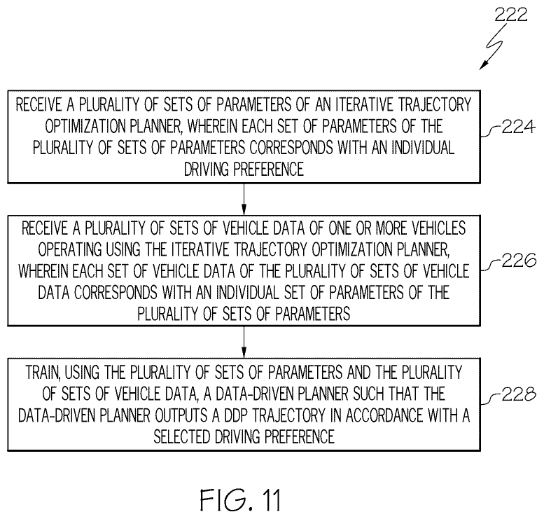

FIG. 11 illustrates a non-limiting example method 222 for training a data-driven planner. In block 224, the method 222 includes receiving a plurality of sets of parameters of an iterative trajectory optimization planner, wherein each set of parameters of the plurality of sets of parameters corresponds with an individual driving profile indicative of a driving preference. In block 226, the method continues by receiving a plurality of sets of vehicle data of one or more vehicles operating using the iterative trajectory optimization planner, wherein each set of vehicle data of the plurality of sets of vehicle data corresponds with an individual set of parameters of the plurality of sets of parameters. In block 228, the method 222 trains, using the plurality of sets of parameters and the plurality of sets of vehicle data, a data-driven planner such that the data-driven planner outputs a DDP trajectory in accordance with a selected driving profile.

It should now be understood that embodiments of the present disclosure are directed to systems and methods of training a machine-learning, data-driven planner of an autonomous driving system. More particularly, the systems and methods described herein leverage the parameters of an iterative trajectory optimization planner of the autonomous driving system as labeled training data to train the data-driven planner to produce trajectories for different driving profiles.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An autonomous vehicle comprising:
one or more processors;
a non-transitory computer-readable medium storing instructions that, when executed by the one or more processors, cause the one or more processors to:
receive a driving preference;
receive local scene data;
input the local scene data into a data-driven planner and an iterative trajectory optimization planner;
generate, using the data-driven planner, a DDP output comprising a DDP trajectory based at least in part on the local scene data and the driving preference;
input the DDP output into the iterative trajectory optimization planner, wherein the DDP output is used as a cost of a plurality of costs of a cost function that is minimized by the iterative trajectory optimization planner; and
generate, using the iterative trajectory optimization planner, an output trajectory.

2. The autonomous vehicle of claim 1, wherein the data-driven planner is trained using a plurality of sets of parameters of the iterative trajectory optimization planner.

3. The autonomous vehicle of claim 2, wherein each set of parameters of the plurality of sets of parameters corresponds with an individual driving preference.

4. The autonomous vehicle of claim 1, further comprising an electronic display, wherein:
the instructions further cause the one or more processors to display a plurality of driving preferences; and
the driving preference is an individual driving preference of the plurality of driving preferences.

5. The autonomous vehicle of claim 4, wherein the driving preference is received by a selection on the electronic display.

6. The autonomous vehicle of claim 1, wherein the driving preference is one of a sport preference, a comfort preference, and an eco-preference.

7. The autonomous vehicle of claim 1, wherein the instructions further cause the one or more processors to receive a new driving preference such that the DDP output is based on the new driving preference.

8. The autonomous vehicle of claim 7, wherein the instructions further cause the one or more processors to update the parameters of the iterative trajectory optimization planner based on the new driving preference.

9. A method of training an autonomous vehicle, the method comprising:
receiving a plurality of sets of parameters of an iterative trajectory optimization planner, wherein each set of parameters of the plurality of sets of parameters corresponds with an individual driving preference indicative of a driving preference;
receiving a plurality of sets of vehicle data of one or more vehicles operating using the iterative trajectory optimization planner, wherein each set of vehicle data of the plurality of sets of vehicle data corresponds with an individual set of parameters of the plurality of sets of parameters; and
training, using the plurality of sets of parameters and the plurality of sets of vehicle data, a data-driven planner such that the data-driven planner outputs a DDP trajectory in accordance with a selected driving preference.

10. The method of claim 9, wherein the data-driven planner is trained using a plurality of sets of parameters of the iterative trajectory optimization planner.

11. The method of claim 10, wherein each set of parameters of the plurality of sets of parameters corresponds with an individual driving preference.

12. The method of claim 9, wherein parameters of the plurality of sets of parameters comprise a plurality of weights and a plurality of constraints of individual optimization problems of the iterative trajectory optimization planner.

13. The method of claim 9, further comprising:
receiving vehicle data from a plurality of vehicles, each vehicle autonomously controlled by the iterative trajectory optimization planner, wherein parameters of the iterative trajectory optimization planner are different among at least some of the plurality of vehicles;
clustering the vehicle data into a plurality of sets based on vehicle data; and
generating a set of parameters for each set of the plurality of sets based at least in part on parameters associated with the vehicle data within each set.

14. The method of claim 9, wherein generating the set of parameters comprises averaging individual parameters within each set.

15. A computing apparatus comprising:
one or more processors; and
a non-transitory memory component storing instructions that, when executed by the one or more processors, configure the computing apparatus to:
receive a plurality of sets of parameters of an iterative trajectory optimization planner, wherein each set of parameters of the plurality of sets of parameters corresponds with an individual driving preference;
receive a plurality of sets of vehicle data of one or more vehicles operating using the iterative trajectory optimization planner, wherein each set of vehicle data of the plurality of sets of vehicle data corresponds with an individual set of parameters of the plurality of sets of parameters; and
train, using the plurality of sets of parameters and the plurality of sets of vehicle data, a data-driven planner such that the data-driven planner outputs a DDP trajectory in accordance with a selected driving preference.

16. The computing apparatus of claim 15, wherein the data-driven planner is trained using a plurality of sets of parameters of the iterative trajectory optimization planner.

17. The computing apparatus of claim 16, wherein each set of parameters of the plurality of sets of parameters corresponds with an individual driving preference.

18. The computing apparatus of claim 15, wherein parameters of the plurality of sets of parameters comprise a plurality of weights and a plurality of constraints of individual optimization problems of the iterative trajectory optimization planner.

19. The computing apparatus of claim 9, wherein the instructions further configure the computing apparatus to:
receive vehicle data from a plurality of vehicles, each vehicle autonomously controlled by the iterative trajectory optimization planner, wherein parameters of the iterative trajectory planner are different among at least some of the plurality of vehicles;
cluster the vehicle data into a plurality of sets based on vehicle data; and
generate a set of parameters for each set of the plurality of sets based at least in part on parameters associated with the vehicle data within each set.

20. The computing apparatus of claim 15, wherein generating the set of parameters comprises averaging individual parameters within each set.
